(19) United States
(12) Patent Application Publication
(10) Pub. No.: US 2015/0294604 A1
(43) Pub. Date: Oct. 15, 2015

(54) Toy display frame with restickable surface

(71) Applicant: Jason YS Kahng, Toronto (CA)

(72) Inventor: Jason YS Kahng, Toronto (CA)

(21) Appl. No.: 14/253,008

(22) Filed: Apr. 15, 2014

(51) Int. Cl. G09F 15/00

(52) U.S. Cl. CPC G09F 15/0006

(57) ABSTRACT

A toy display frame that allows users to attach and detach small toys over and over again to its restickable surface with no modification to the toys themselves. The frame allows users to better organize and display small toys. Users can also hang the display with their small toys attached to it.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Toys. It is not uncommon for children to have hundreds of individual toy pieces in the house. Keeping small toys organized is especially challenging for they are hard to keep track of and easy to lose. This invention is designed to bring order to some of the more important small toys.

The invention is a specially designed display frame with raised surfaces on which a special adhesive is attached. This combination of specially designed raised surface and special adhesive creates a functional display that allows users to attach and detach small toys over and over again without making any special modification to them.

### BRIEF SUMMARY OF THE INVENTION

The invention is a unique product that allows users to attach small toys to it for organizational and display purposes. No other known display frame allows users to attach and detach small toys to it over and over again without making any modifications to the toys themselves. This facilitates better organization of the user's small toys thus reducing risk of small toy loss and makes an attractive display.

### BRIEF DESCRIPTION OF THE SEVERAL VIEWS OF THE DRAWING

FIG. 1 is a front perspective view the invention. The three horizontal bars in the center of the frame are raised from the surrounding board. The restickable adhesives are attached to this raised surface.

FIG. 2 is a partial cross section of the invention. One of the raised sections with the adhesive is shown with a toy figure of a man with a helmet. The shape of the bars allows for better adhesion between the toy and the display because a larger portion of the toy's surface can contact the adhesive. For example, toy figures of people with helmets where the round of the helmets protrude outwards from the line of the back of the figure. By placing the helmet above the adhesive bars and placing the torso and legs of the toy figure directly on the adhesive, a substantially larger portion of the toy figure can make full contact with the adhesive and the head with helmet can hang over the edge. Without the raised sections, the above-mentioned toy figure would contact the adhesive bars at two small spots, one at the helmet and one at one point on the torso and/or legs.

### DETAILED DESCRIPTION OF THE INVENTION

Toys. It is not uncommon for children to have hundreds of individual toy pieces in the house. Keeping small toys organized is especially challenging for they are hard to keep track of and easy to lose. This invention is designed to bring order to some of the more important small toys. The invention is a specially designed display frame with raised surfaces on which a special adhesive is attached. This combination of specially designed raised surface and special adhesive creates a functional display that allows users to attach and detach small toys over and over again without making any special modification to them.

The shape of the bars allows for better adhesion between certain types of toys, such as figurines where the head protrudes from the line of the torso, and the display because a larger portion of surface can contact the adhesive.

The special adhesive allows users to attach and detach small toys to its surface over and over again with minimal loss of adhesion. And the adhesive is washable allowing for prolonged tackiness of the restickable surface as debris comes into contact with the adhesive through normal use.

The invention, with all the small toys attached could be hung on a wall for organizational as well as for decorative purposes.

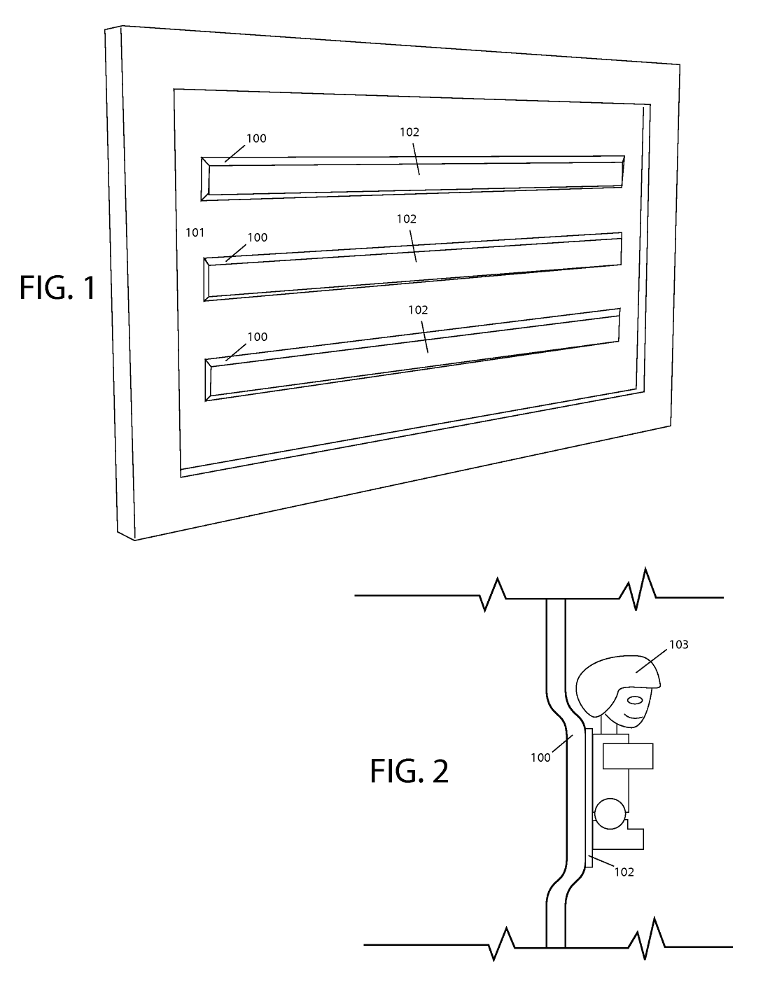

FIG. 1 is a front perspective view the invention. The horizontal bars 101 in the center of the frame are raised from the surrounding board 100. The restickable adhesives 102 are attached to this raised surface 101. The raised surface allows certain types of toys to adhere to a larger portion of its surface creating a stronger bond.

FIG. 2 is a partial cross section of the invention. The raised surfaces 101 allows certain shaped toys to adhere to a larger portion of the adhesive 102. For example, take a toy figure of a person with a helmet where the round of the helmet protrudes outwards from the line of the back of the FIG. 103. By placing the helmet above the adhesive bars and placing the torso and legs of the toy figure directly on the adhesive 102, a substantially larger portion of the toy FIG. 103 can make full contact with the adhesive 102 and the head with helmet can hang over the edge. Without the raised sections, the above-mentioned toy figure would contact the adhesive bars at two small spots, once at the helmet and once at one point on the torso and/or legs.

I claim:

1. A unique toy display frame comprising:
restickable surfaces on which to attach and detach small toys; and
a display board on which the restickable surface is adhered to.

2. The toy display frame of claim 1, wherein the restickable surface is sticky so as to adhere small toys to the display without any modification to the toys.

3. The toy display frame of claim 1, wherein the restickable surface is reusable so toys can be attached and detached over and over again with minimal loss of adhesion.

3. The toy display frame of claim 1, wherein the restickable surface is washable in order to prolong tackiness of restickable surface.

4. The toy display frame of claim 1, wherein the restickable surface is on a raised surface on the display board in order to allow more of the surface area of certain types of toys to contact the restickable surface.

5. The toy display frame of claim 1, wherein the restickable surface leaves minimal/no sticky residue on toys that are attached and detached to the restickable surface.
